(19) United States
(12) Patent Application Publication
(10) Pub. No.: US 2018/0319963 A1
(43) Pub. Date: Nov. 8, 2018

(54) EXTRUSION AGENT FOR POLYOLEFINS

(71) Applicant: Arkema France, Colombes (FR)

(72) Inventors: Samuel DEVISME, Rouen (FR); François BEAUME, Saint Genis Laval (FR); Ludovic LUCE, Ymare (FR)

(21) Appl. No.: 15/779,881

(22) PCT Filed: Nov. 30, 2016
(86) PCT No.: PCT/FR2016/053151

§ 371 Date: May 30, 2018

(30) Foreign Application Priority Data
Dec. 2, 2015 (FR) 1561724

(51) Int. Cl. C08L 23/06; C08J 3/22; B29C 47/00

(52) U.S. Cl. CPC C08L 23/06; C08J 3/226; B29C 47/0004; B29K 2027/16; C08J 2323/06; C08J 2327/16; B29K 2023/06; C08L 2205/06

(57) ABSTRACT

The invention relates to the use of a composition as an extrusion agent for the production of an extruded product, wherein: the extruded product comprises a polyolefin, as well as fillers in a concentration greater than or equal to 15% by weight; the composition used comprising a fluorinated polymer having a viscosity less than or equal to 15 kP at a temperature of 232° C. and at a shear rate of 100 s⁻¹. The invention also relates to an extrusion method for a polyolefin supplemented with fillers, in the presence of such an extrusion agent.

### FIELD OF THE INVENTION

The present invention relates to a polymer processing aid for the manufacture of extruded products based on polyolefins, and also to the use of this polymer processing aid in an extrusion process.

### TECHNICAL BACKGROUND

Polyolefins, such as polyethylene, are of use in the manufacture of various objects by extrusion. They can be used with or without fillers, depending on the applications. It is known to use polymer processing aids for improving the properties of the extruded products.

One particular problem which is encountered, in particular during the manufacture of sheets, tubes, films or strips starting from filler-comprising polyolefins, is the appearance of build-up at the outlet of the extrusion die. This build-up can create surface defects and a detrimental change in the mechanical properties of the extruded products.

These are specific defects which are distinct from other surface defects which are liable to appear independently of any build-up at the die outlet, such as, for example, defects related to an unevenness in the flow.

3M sells polymer processing aids of the Dynamar™ range, which are in particular supposed to reduce build-up at the die outlet during the extrusion of polyethylene films. These polymer processing aids comprise fluoropolymers which are high-viscosity fluoroelastomers.

The document EP 1 616 907 describes a masterbatch comprising a fluoropolymer, a polyolefin and an interfacial agent and its use as polymer processing aid. The problem of build-up at the die outlet during the extrusion of a filler-comprising polyolefin is not specifically tackled in the document.

The document WO 2007/080338 describes the use of a heterogeneous polyvinylidene fluoride as a mixture with an interfacial agent and optionally a polyolefin, as polymer processing aid for a thermoplastic resin. The purpose of the polymer processing aid is to reduce certain surface defects. The problem of build-up at the die outlet during the extrusion of a filler-comprising polyolefin is not specifically tackled in the document.

The documents WO 02/066544, WO 03/040232, WO 2005/019334, WO 2010/135018 and US 2011/0172338 also describe various polymer processing aids based on fluoropolymers. These polymer processing aids are of high viscosity and/or do not have the subject matter of solving the problem posed by build-up at the die outlet during the extrusion of a filler-comprising polyolefin.

There thus exists a real need to have available a polymer processing aid which makes it possible to reduce build-up at the die outlet during the extrusion of filler-comprising polyolefins.

### SUMMARY OF THE INVENTION

The invention relates first to the use of a composition as polymer processing aid in the manufacture of an extruded product, in which:
the extruded product comprises a polyolefin, and also fillers in a content of greater than or equal to 15% by weight;
the composition used comprises a fluoropolymer exhibiting a viscosity of less than or equal to 15 kP at a temperature of 232° C. and at a shear rate of 100 s⁻¹.

According to one embodiment, the fluoropolymer exhibits a viscosity of less than or equal to 10 kP, preferably of less than or equal to 5 kP, at a temperature of 232° C. and at a shear rate of 100 s⁻¹.

According to one embodiment, the fluoropolymer is a polymer comprising units resulting from vinylidene fluoride and is preferably chosen from polyvinylidene fluoride homopolymer and copolymers comprising vinylidene fluoride units and units resulting from at least one other comonomer chosen from chlorotrifluoroethylene, hexafluoropropylene, trifluoroethylene, tetrafluoroethylene and ethylene; and, more particularly preferably, the copolymers contain at least 75% by weight of units resulting from vinylidene fluoride and more preferably still at least 80% by weight of units resulting from vinylidene fluoride.

According to one embodiment, the extruded product comprises a content of fillers of 20% to 70% by weight, preferably of 30% to 55% by weight.

According to one embodiment, the fillers are chosen from silica, alumina, zeolite, titanium oxide, calcium carbonate, sodium carbonate, potassium carbonate, hydrotalcite, talc, zinc oxide, magnesium oxide, calcium oxide, diatomaceous earth, carbon black, inorganic pigments and the mixtures of these.

According to one embodiment, the composition used is devoid of synergistic agent.

According to one embodiment, the composition used is a masterbatch comprising the fluoropolymer as a mixture with a polyolefin, preferably with the polyolefin of the extruded product, the proportion by weight of fluoropolymer in the masterbatch preferably being from 1% to 40%, more preferably from 2% to 20%, more particularly preferably from 3% to 10%.

According to one embodiment, the composition used is a masterbatch comprising the fluoropolymer as a mixture with fillers and a polyolefin. The content by weight of fillers is preferably between 20% and 80%, preferably between 30% and 60%.

According to one embodiment, the use of the invention is in the manufacture of films, sheets, tubes or strips.

The invention also relates to a process for the extrusion of a polyolefin additivated with fillers, in the presence of a polymer processing aid, which makes it possible to obtain an extruded product, in which the polymer processing aid comprises a fluoropolymer exhibiting a viscosity of less than or equal to 15 kP at a temperature of 232° C. and at a shear rate of 100 s⁻¹, and in which the extruded product comprises a content of fillers of greater than or equal to 15% by weight.

According to one embodiment, the fluoropolymer is as described above.

According to one embodiment, the fillers are as described above and/or are present in the extruded product in the content described above.

According to one embodiment, the polymer processing aid is a composition as described above.

According to one embodiment, the polymer processing aid is used in an amount such that the content by weight of fluoropolymer in the extruded product is from 0.01% to 1%, preferably from 0.02% to 0.5% and more particularly preferably from 0.02% to 0.15%.

According to one embodiment, the extruded product is a film, a sheet, a tube or a strip.

The present invention makes it possible to overcome the disadvantages of the state of the art. It more particularly provides polymer processing aids which make it possible to reduce build-up at the die outlet during the extrusion of filler-comprising polyolefins.

This is accomplished by virtue of recourse to a fluoropolymer, in particular a polyvinylidene fluoride (PVDF) or derivative, of low viscosity.

The polymer processing aid of the invention also makes it possible to improve the other aspects of the extrusion process: decrease in pressure, improvement in the surface condition, and the like.

According to a preferred embodiment of the invention, the polymer processing aid is devoid of any interfacial agent. It has been discovered, surprisingly, that the absence of an interfacial agent, in the specific context which is that of the invention, improves the parameters of the extrusion.

### DESCRIPTION OF EMBODIMENTS OF THE INVENTION

The invention is now described in greater detail and in a nonlimiting manner in the description which follows.

The polymer processing aid according to the invention comprises a fluoropolymer, that is to say a polymer comprising fluorine substituents.

Preferably, it is a PVDF homopolymer or a copolymer derived from PVDF. Such copolymers are obtained by copolymerization of vinylidene fluoride (VDF) with at least one other comonomer which is advantageously chosen from chlorotrifluoroethylene (CTFE), hexafluoropropylene (HFP), trifluoroethylene (TrFE), tetrafluoroethylene (TFE) and ethylene.

Several comonomers can optionally be used.

Advantageously, said copolymer contains at least 75% by weight of units resulting from the VDF comonomer, preferably at least 80%, indeed even at least 85%.

Advantageously, the fluoropolymer of the polymer processing aid of the invention is a thermoplastic polymer (in contrast to a fluoroelastomer). The fluoropolymers containing a high proportion of units resulting from the VDF comonomer have a tendency to be thermoplastic.

“Thermoplastic” is understood here to mean a nonelastomeric polymer. An elastomeric polymer is defined as being a polymer which can be drawn, at ambient temperature, to twice its initial length and which, after releasing the stress, rapidly resumes its initial length, to within about 10%, as indicated by the ASTM in the Special Technical Publication, No. 184.

The invention provides for the fluoropolymer according to the invention to exhibit a viscosity of less than or equal to 15 kP.

The viscosity is measured at 232° C., at a shear rate of 100 s⁻¹, using a capillary rheometer or a parallel plate rheometer, according to the standard ASTM D3825 (the two methods give similar results; in the event of a hypothetical discrepancy, the capillary rheometer method would be selected).

According to specific embodiments, the fluoropolymer used in the invention exhibits a viscosity of less than or equal to 14 kP, or to 13 kP, or to 12 kP, or to 11 kP, or to 10 kP, or to 9 kP, or to 8 kP, or to 7 kP, or to 6 kP, or to 5 kP, or to 4 kP, or to 3 kP, or to 2 kP, or to 1 kP, or to 0.5 kP.

The fluoropolymer used in the invention can be obtained by known polymerization methods, such as solution, emulsion or suspension polymerization. According to one embodiment, it is prepared by an emulsion polymerization process in the absence of a fluorinated surface-active agent.

The fluoropolymer used in the invention preferably exhibits a number-average molecular weight ranging from 5 kDa to 200 kDa, preferably from 10 kDa to 120 kDa, as measured by size exclusion chromatography in 0.003 M LiBr/DMF with polymethyl methacrylate as calibration standard.

Such a fluoropolymer of low molecular weight can be obtained in particular by using a high content of one or more chain-transfer agents during the polymerization process. According to one embodiment, chain-transfer agents suitable for this purpose are chosen from:
short-chain hydrocarbons, such as ethane and propane,
esters, such as ethyl acetate and diethyl maleate,
alcohols, carbonates, ketones,
halocarbons and hydrohalocarbons, such as chlorocarbons, hydrochlorocarbons, chlorofluorocarbons and hydrochlorofluorocarbons,
organic solvents, when they are added to an emulsion or suspension polymerization reaction.

Other factors which promote the production of low molecular weight polymers are carrying out the polymerization reaction at high temperatures or also the use of high levels of initiator.

The fluoropolymer used in the invention, when it is a copolymer, can be homogeneous or heterogeneous, and preferably homogeneous. A homogeneous polymer exhibits a uniform chain structure, the statistical distribution of the comonomers not varying between the polymer chains. In a heterogeneous polymer, the polymer chains exhibit a distribution in average content of comonomers of multimodal or spread type; it thus comprises polymer chains rich in a comonomer and polymer chains poor in said comonomer. An example of heterogeneous PVDF appears in the document WO 2007/080338.

A homogeneous copolymer can be prepared by a single-stage process, in which the comonomers are gradually injected while keeping constant a ratio by weight between them.

The polymer processing aid according to the invention can optionally comprise one or more additives as a mixture with the fluoropolymer. The additives can in particular be chosen from antioxidants and more particularly primary antioxidants of phenolic or hindered phenolic type and/or secondary antioxidants chosen from phosphorus components (phosphonites and/or phosphites).

According to one embodiment, the polymer processing aid of the invention can also comprise an interfacial agent.

According to another embodiment, which is preferred, the polymer processing aid of the invention is devoid of an interfacial agent.

“Interfacial agent” or synergistic agent is understood to mean a surface-active agent which is a thermoplastic oligomer or polymer occurring in the liquid or molten state at the extrusion temperature and having a melt viscosity which is less than that of the polymer to be extruded and of the additives used.

Mention may be made, as examples of interfacial agent, of silicones, silicone/polyether copolymers, aliphatic polyesters, aromatic polyesters, such as, for example, phthalic acid diisobutyl ester, polyethers, such as, for example, polyether polyols and poly(alkylene oxide)s, amine oxides, such as, for example, octyldimethylamine oxide, carboxylic acids, such as, for example, hydroxybutanedioic acid, or fatty acid esters.

Mention may be made, as examples of aliphatic polyester, of polylactic acid and polycaprolactones.

The interfacial agent can in particular be a polyether preferably chosen from oligomers or polymers having alkylene oxide (for example ethylene oxide or propylene oxide) units. Mention may be made, as example, of poly(oxyethylene) glycol, commonly known as polyethylene glycol (PEG), advantageously with a number-average molecular weight Mn of between 400 and 15 000 g/mol and a melting point of between 50° C. and 80° C.

Thus, according to a preferred embodiment, the polymer processing aid of the invention is devoid of polyethylene glycol and advantageously of any other abovementioned interfacial agent.

The polymer processing aid of the invention is intended to be used for the extrusion of a polyolefin-based material which contains fillers.

The polyolefin can in particular be chosen from:
a polyethylene, in particular a low-density polyethylene (LDPE), a high-density polyethylene (HDPE), a linear low-density polyethylene (LLDPE) and an ultra-high-density polyethylene (UHDPE);
a polypropylene, in particular an isotactic or syndiotactic polypropylene;
a polybutylene (obtained from 1-butene);
a poly(3-methylbutene);
a poly(4-methylpentene).

It is also possible to use a mixture of several polyolefins.

The fillers can be organic fillers and/or inorganic fillers, preferably inorganic fillers.

Use may in particular be made, as inorganic fillers, of silica, alumina, zeolite, titanium oxide, carbonate (for example calcium, sodium or potassium carbonate), hydrotalcite, talc, zinc oxide, magnesium oxide, calcium oxide, diatomaceous earth, carbon black and/or inorganic pigments.

Use may in particular be made, as organic filler, of an organic pigment, an antioxidant, a UV absorber, a sterically hindered amine photostabilizer (HALS), a slip agent, an antiblock agent, an antifogging agent or an anti-water-repelling agent.

In the invention, the fillers are used at a content of greater than or equal to 15% by weight, with respect to the total extruded composition (polyolefin, fillers, polymer processing aid, possible additional additives), or, equivalently, at a content of greater than or equal to 15% by weight, with respect to the extruded product.

According to some specific embodiments, this content by weight of fillers can be: from 15% to 20%; or from 20% to 25%; or from 25% to 30%; or from 30% to 35%; or from 35% to 40%; or from 40% to 45%; or from 45% to 50%; or from 50% to 55%; or from 55% to 60%; or from 60% to 65%; or from 65% to 70%.

According to a first embodiment, the polymer processing aid can consist of or can essentially comprise the fluoropolymer described above. Optionally, it can additionally comprise one or more additives.

According to a second embodiment, the polymer processing aid can be a masterbatch comprising the fluoropolymer described above and also a portion of the polyolefin which has to be extruded (and optionally one or more additives). In this case, the proportion by weight of fluoropolymer in the polymer processing aid can vary more preferably still from 1% to 50%, more preferably still from 1% to 25%, more preferably still from 1% to 15%, and more preferentially from 2% to 10%, and more particularly from 3% to 7%. Preferably, in this embodiment, the polymer processing aid consists of or essentially comprises a mixture of fluoropolymer and polyolefin.

According to a third embodiment, the polymer processing aid consists of or essentially comprises a mixture of fluoropolymer, polyolefin and fillers (as described above). Optionally, it can additionally comprise one or more additives. The ratio by weight of the content of fillers, with respect to the sum of the contents of polyolefin, fillers and fluoropolymer, is preferably between 30% and 80%, more particularly preferably between 40% and 60%.

When the polymer processing aid comprises other constituents in addition to the fluoropolymer, and in particular when it is a masterbatch of the second embodiment or of the third embodiment which are described above, it can be manufactured by mixing the different constituents at a temperature such that at least one of the polymers present is in the molten state (preferably all). The mixing can be carried out, for example, by extrusion or kneading, twin-screw extrusion (or co-kneading) being preferred.

The polymer processing aid can be obtained, for example, in the form of granules. It can also be obtained in the powder form, if appropriate by applying an additional grinding stage.

The polymer processing aid is combined with the polyolefin, the fillers and possible additional additives during the extrusion stage.

The amount of polymer processing aid which is used is adjusted so that the content by weight of fluoropolymer in the total mixture (or, equivalently, in the extruded product) is from 0.01% to 1%, preferably from 0.02% to 0.5% and more particularly preferably from 0.02% to 0.15%.

The extrusion stage makes it possible to obtain various extruded products, such as films, sheets, tubes or strips.

### EXAMPLES

The following examples illustrate the invention without limiting it.

In the examples, the following fluoropolymers are used:
Polymer A: P(VDF-HFP) copolymer from Arkema, with a content by weight of HFP of approximately 18%, a melting point of approximately 130° C. and a viscosity of 0.4 kP;
Polymer B: PVDF homopolymer from Arkema, with a melting point of approximately 168° C. and a viscosity of 3.5 kP;
Polymer C: heterophasic P(VDF-HFP) copolymer from Arkema, with a content by weight of HFP of approximately 10%, a melting point of approximately 166° C. and a viscosity of 11 kP;
Polymer D: heterophasic P(VDF-HFP) copolymer from Arkema, with a content by weight of HFP of approximately 10%, a melting point of approximately 166° C. and a viscosity of 24 kP;
Polymer E: P(VDF-HFP) copolymer from Arkema, with a content by weight of HFP of approximately 11%, a melting point of approximately 142° C. and a viscosity of 16 kP;
Polymer F: Dynamar™ FX5911 copolymer from 3M, having a viscosity of 27 kP, measured at 232° C. at a shear rate of 100 s⁻¹ using a capillary rheometer or a parallel plate rheometer, according to the standard ASTM D3825.

The polyolefin used is a metallocene polyethylene having a melt flow index of 15, as measured according to the standard ASTM D1238 (at 190° C. and at 2.16 kg), supplied by Ineos (Eltex PF1315AA grade, additive-free).

Use is made, as fillers, of calcium carbonate (CaCO₃), supplied by Omya (Omyafilm 707 OG grade; particle size analysis: particle size fraction (d98%)=6 μm, mean diameter of the particles (d50%)=1.6 μm). The different compounds were produced on a corotating twin-screw extruder at 310 rev/min, at a temperature of 200° C. and a throughput of 70 kg/h.

Different masterbatches are manufactured, in the form of granules, by mixing 5% by weight of any one of the polymers A to E above with 95% by weight of polyolefin. The masterbatches are manufactured by extrusion on a corotating twin-screw extruder at 250 rev/min, with a throughput of 2.5 kg/h. A flat profile at 190° C. (with zone 1 at 160°) is used.

These masterbatches A to E are subsequently used as polymer processing aids, as described below.

### Example 1—Extrusion at a Content of Fillers of 55%

In this example, experiments on extrusion at 200° C. of polyolefin (described above) with 55% by weight of fillers on an extruder from Collin having a screw diameter of 30 mm, a length/diameter ratio of 25 and a capillary die with a diameter of 0.5 mm and a length of 10 mm are carried out.

After extruding for 15 minutes, one of the different masterbatches described above is introduced at a content of 2% by weight, in order to obtain a dosage of 1000 ppm of fluoropolymer in the final composition. The rod is subsequently cut and the die cleaned before the start of the analysis. The analysis consists in extruding and monitoring, over time, the volume of die build-up which is formed, by analysis of an image taken by a camera.

A control without masterbatch (filler-comprising polyolefin extruded without polymer processing aid) is also employed.

The results are summarized in table I below:

TABLE I

| | Viscosity of the | Volume of |
|---|---|---|
| | fluoropolymer (at 232° C. | die build-up after |
| Masterbatch | and 100 s⁻¹) | extruding for 20 minutes |
| B (invention) | 3.5 kP | 58 mm³ |
| C (invention) | 11 kP | 32 mm³ |
| D (comparative) | 24 kP | 184 mm³ |
| E (comparative) | 16 kP | 100 mm³ |
| F (comparative) | 27 kP | 165 mm³ |
| None (control) | — | 250 mm³ |

It is found that the masterbatches containing fluoropolymers of low viscosity (B and C) are those which make it possible to best of all limit the appearance of die build-up, with respect to the reference and to the comparative tests D, E and F.

### Example 2—Extrusion at a Content of Fillers of 30%

This example is carried out in the same way as the preceding one, except that the content by weight of fillers in the polyolefin is reduced to 30%.

The results are summarized in table II below:

TABLE II

| | Viscosity of the | Volume of |
|---|---|---|
| | fluoropolymer (at 232° C. | die build-up after |
| Masterbatch | and 100 s⁻¹) | extruding for 20 minutes |
| A (invention) | 0.4 kP | 13 mm³ |
| B (invention) | 3.5 kP | 0.3 mm³ |
| D (comparative) | 24 kP | 143 mm³ |
| E (comparative) | 16 kP | 221 mm³ |
| F (comparative) | 27 kP | 95 mm³ |
| None (control) | — | 15 mm³ |

Again, it is found that the use of a masterbatch containing a fluoropolymer of low viscosity (A and B) makes it possible to best of all limit the appearance of die build-up for a PE comprising, as filler, 30% of calcium carbonate. The fluoropolymers of high viscosity (comparative tests D, E and F) worsen the problem of die build-up, in comparison with the control without polymer processing aid.

1. An extruded product comprising:
a. a polymer processing aid comprising a fluoropolymer exhibiting a viscosity of less than or equal to 15 kP at a temperature of 232° C. and at a shear rate of 100 s⁻¹
b. a polyolefin, and
c. fillers in a content of greater than or equal to 15% by weight.

2. The extruded product as claimed in claim 1, in which the fluoropolymer exhibits a viscosity of less than or equal to 10 kP, at a temperature of 232° C. and at a shear rate of 100 s⁻¹.

3. The extruded product as claimed in claim 1, in which the fluoropolymer is a polymer chosen from polyvinylidene fluoride homopolymer and copolymers comprising vinylidene fluoride units and units from at least one other comonomer chosen from chlorotrifluoroethylene, hexafluoropropylene, trifluoroethylene, tetrafluoroethylene and ethylene; and in which the copolymers contain at least 75% by weight of vinylidene fluoride monomer units.

4. The extruded product as claimed in claim 1, in which the extruded product comprises a content of fillers of 20% to 70% by weight.

5. The extruded product as claimed in claim 1, in which the fillers are selected from the group consisting of silica, alumina, zeolite, titanium oxide, calcium carbonate, sodium carbonate, potassium carbonate, hydrotalcite, talc, zinc oxide, magnesium oxide, calcium oxide, diatomaceous earth, carbon black, inorganic pigments and the mixtures of these.

6. The extruded product as claimed in claim 1, in which the composition used is devoid of synergistic agent.

7. The process as claimed in claim 10, in which the fluoropolymer is added as a masterbatch mixture with a polyolefin, the proportion by weight of fluoropolymer in the masterbatch being from 1% to 50%.

8. The process as claimed in claim 10, in which the fluoropolymer is added as a masterbatch mixture with fillers and a polyolefin, the content by weight of fillers in the composition preferably being between 30% and 80%.

9. The extruded product as claimed in claim 1, wherein said extruded product is a film, sheet, tubes, or strip.

10. A process for the extrusion of a polyolefin comprising fillers, in the presence of a polymer processing aid, in which the polymer processing aid comprises a fluoropolymer exhibiting a viscosity of less than or equal to 15 kP at a temperature of 232° C. and at a shear rate of 100 s⁻¹, and in which the extruded product comprises a content of fillers of greater than or equal to 15% by weight.

11. The process as claimed in claim 10, in which the fluoropolymer exhibits a viscosity of less than or equal to 10 kP, at a temperature of 232° C. and at a shear rate of 100 s⁻¹; and in which the fluoropolymer is a polymer chosen from polyvinylidene fluoride homopolymer and copolymers comprising vinylidene fluoride units and units from at least one other comonomer chosen from chlorotrifluoroethylene, hexafluoropropylene, trifluoroethylene, tetrafluoroethylene and ethylene; and in which, the copolymers contain at least 75% by weight of vinylidene fluoride monomer units.

12. The process as claimed in claim 10, in which the extruded product comprises a content of fillers of 20% to 70% by weight, and in which the fillers are selected from the group consisting of silica, alumina, zeolite, titanium oxide, calcium carbonate, sodium carbonate, potassium carbonate, hydrotalcite, talc, zinc oxide, magnesium oxide, calcium oxide, diatomaceous earth, carbon black, inorganic pigments and the mixtures of these.

13. (canceled)

14. The process as claimed in claim 10, in which the polymer processing aid is used in an amount such that the content by weight of fluoropolymer in the extruded product is from 0.01% to 1%.

15. (canceled)

16. The extruded product as claimed in claim 1, in which the fluoropolymer exhibits a viscosity of less than or equal to 5 kP at a temperature of 232° C. and at a shear rate of 100 s⁻¹.

17. The extruded product as claimed in claim 4, in which the extruded product comprises a content of fillers of 30% to 55% by weight.

18. The process as claimed in claim 7, wherein the proportion by weight of fluoropolymer in the masterbatch is from 2% to 10%.

19. The process as claimed in claim 18, wherein the proportion by weight of fluoropolymer in the masterbatch is from 3% to 7%.

20. The process as claimed in claim 8, in which the wherein the content by weight of fillers in the composition preferably being between 40% and 60%.
